(19) United States
(12) Patent Application Publication
(10) Pub. No.: US 2026/0111583 A1
(43) Pub. Date: Apr. 23, 2026

(54) METHOD AND SYSTEM FOR BOOTSTRAPPING INFRASTRUCTURE AS A SERVICE DATA CENTERS WITHIN AN ENTERPRISE NETWORK

(71) Applicant: JPMorgan Chase Bank, N.A., New York, NY (US)

(72) Inventor: Kishor KUNAL, Begusarai (IN)

(73) Assignee: JPMorgan Chase Bank, N.A., New York, NY (US)

(21) Appl. No.: 18/978,773

(22) Filed: Dec. 12, 2024

(30) Foreign Application Priority Data
Oct. 23, 2024 (IN) 202411080701

(51) Int. Cl. G06F 21/62; G06F 9/455; H04L 9/40

(52) U.S. Cl. CPC G06F 21/6218; G06F 9/45558; H04L 63/02; G06F 2009/45575; G06F 2009/45595

(57) ABSTRACT

A method for implementing an Infrastructure-as-a-Service (IaaS) data center within an enterprise network. The method may comprise identifying, based on a location of data center infrastructure for hosting the IaaS data center, a local jurisdiction of the data center infrastructure; correlating the IaaS data center to a first data center type that is associated with at least one requirement from among a first set of data protection and privacy requirements that pertain to the local jurisdiction; instantiating the IaaS data center by virtualizing the first data center type within the data center infrastructure; configuring a first set of monitoring platforms to manage and control a first set of configurations of the IaaS data center; and deploying, from the data center infrastructure, the IaaS data center to at least one data center user of the enterprise network.

### CROSS-REFERENCE TO RELATED APPLICATIONS

This application claims priority benefit from Indian Application No. 202411080701, filed Oct. 23, 2024, which is hereby incorporated by reference in its entirety.

### BACKGROUND

### 1. Field of the Invention

The field of the invention disclosed herein generally relates to implementations of Infrastructure as a Service (IaaS) data centers and, more particularly, to a method, system, and computer-readable medium for bootstrapping an implementation of an IaaS data center within an enterprise network.

### 2. Background of the Invention

Electronic data centers are ubiquitous in Internet-based environments, such that their services typically serve as the underlying infrastructure for virtually every Internet-based application that is available in today's global market. However, data center operators that operate in different geographical (and/or virtual) locations must often comply different legal regulations that pertain to such operations, and these different regulations may even conflict in what they require of data centers that are located in their respective jurisdictions.

Unfortunately, regulatory changes may force the infrastructural engineering efforts of affected data center operators to implement one or more data centers on the fly, which tends to result in incompatible and/or inconsistent data center implementations. However, conventional approaches to such on-the-fly data center implementations are inefficient and can lag behind an effective date of a critical regulatory change, which would render any associated data center(s) non-compliant with regard to such regulation(s).

Therefore, there is a need in the field of data center technology for an improvement to existing data center implementation technology in order to implement data centers on the fly but in a more timely, consistent, and interoperable manner.

### SUMMARY

The present disclosure, through one or more of its various aspects, embodiments, and/or specific features or sub-component, provides, inter alia, various systems, servers, devices, methods, media, programs and platforms for implementing an Infrastructure-as-a-Service (IaaS) data center within an enterprise network.

According to an aspect of the present disclosure, a method is provided for implementing an IaaS data center within an enterprise network. The method may comprise: identifying, based on a location of data center infrastructure for hosting the IaaS data center, a local jurisdiction of the data center infrastructure; correlating the IaaS data center to a first data center type that is associated with at least one requirement from among a first set of data protection and privacy requirements that pertain to the local jurisdiction; instantiating the IaaS data center by virtualizing the first data center type within the data center infrastructure; configuring a first set of monitoring platforms to manage and control a first set of configurations of the IaaS data center; and deploying, from the data center infrastructure, the IaaS data center to at least one data center user of the enterprise network.

In the method, the virtualizing may comprise at least one from among: configuring the data center infrastructure to implement a first hypervisor and virtual machine topology, wherein the first data center type comprises the first hypervisor and virtual machine topology; implementing a first operating system (OS) layer on top of the first hypervisor and virtual machine topology; configuring the first OS layer to include a first set of data center directories; and configuring the first OS layer to utilize a first protocol to provide access to the first set of data center directories.

In the method, the first protocol may comprise at least one from among a lightweight directory access protocol (LDAP) and an active directory protocol.

In the method, the first data center type may comprise at least one data center network tier from among a plurality of data center network tiers, and the plurality of data center network tiers may comprise: a third tier that includes an isolated internal data center network that may be inaccessible to an external network; a first tier that includes an accessible internal data center network that may be accessible to the external network; and a second tier that includes an intermediary internal data center network that may be configured to communicate only with the isolated internal data center network and the accessible internal data center network. The isolated internal data center network may be configured to communicate only with the intermediary internal data center network, the accessible internal data center network may be configured to communicate with the intermediary internal data center network, the intermediary internal data center network may be configured to communicate only with the isolated internal data center network and the accessible internal data center network, and the external network may comprise the enterprise network.

In the method, configuring the first set of monitoring platforms may comprise configuring at least a first monitoring platform from among the first set of monitoring platforms to perform at least one from among the following operations: determine, by monitoring a first set of performance metrics of the IaaS data center, whether the first set of performance metrics comprises a first performance drift of the IaaS data center; adjust the first set of configurations to compensate for the first performance drift; replace a defective component of the data center infrastructure with a properly functioning instance of the defective component; and stock an inventory of the IaaS data center with a new instance of the defective component.

In the method, configuring the first set of monitoring platforms may comprise configuring at least a second monitoring platform from among the first set of monitoring platforms to perform at least one from among the following operations: determine, by monitoring the first set of data protection and privacy requirements, whether the first set of data protection and privacy requirements comprises a critical change pertaining to the IaaS data center; and reconfigure the IaaS data center in accordance with the critical change of the first set of data protection and privacy requirements that pertain to the local jurisdiction.

In the method, the correlating may comprise determining, based on the requirement, that the first data center type comprises a first enterprise environment from among the following enterprise environments: a local enterprise environment that provides the enterprise network with local access to the IaaS data center; a remote enterprise environment that provides the enterprise network with remote access to the IaaS data center; and an isolated enterprise environment that provides the enterprise network with restricted access to the IaaS data center. In the local enterprise environment, the data center infrastructure may be located within the enterprise. In the remote enterprise environment, the data center infrastructure may be located separately from the enterprise, and the remote access may utilize a communication network. In the isolated enterprise network, the data center infrastructure may be located separately from the enterprise, the IaaS data center may be isolated, the IaaS data center may be accessible only via a private network channel, and the restricted access may utilize the private network channel.

In the method, the IaaS data center may be accessible only via a firewall, and the firewall may be configured to permit at least one from among the remote access and the restricted access.

In the method, the at least one requirement may require that at least one from among secure data of the local jurisdiction and private data of the local jurisdiction is non-transitorily stored only within an environment that is isolated from the enterprise network.

In the method, the at least one requirement may require that at least one from among secure data of the local jurisdiction and private data of the local jurisdiction is non-transitorily stored only within an environment that is located separately from the enterprise network.

Accordingly, the invention disclosed herein provides a novel approach to implementing an IaaS data center within an enterprise network.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 depicts a diagram of an exemplary computer system.

FIG. 2 depicts a diagram of an exemplary environment for implementing an Infrastructure as a Service (IaaS) data center within an enterprise network.

FIG. 3 depicts a diagram of an exemplary perspective of an environment that implements an IaaS data center within an enterprise network.

FIG. 4 depicts a flowchart of an exemplary process for implementing an IaaS data center within an enterprise network.

FIG. 5 depicts a diagram of an exemplary three (3) tier system of an IaaS data center within an enterprise network.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

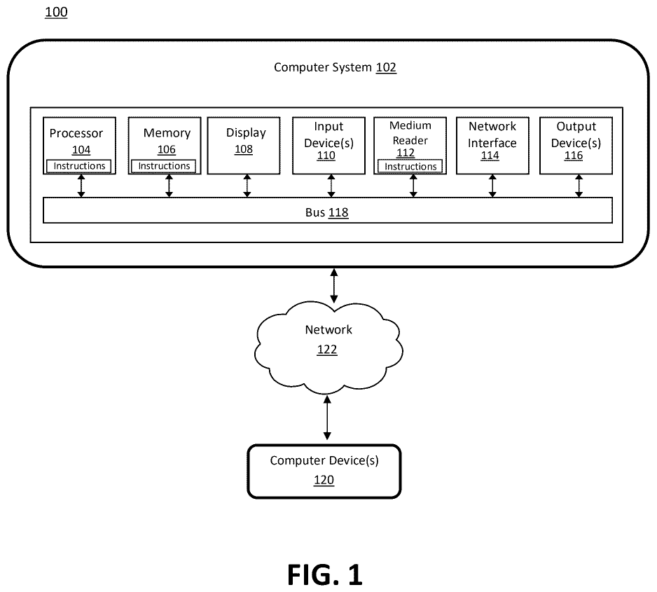

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing an Infrastructure as a Service (IaaS) data center within an enterprise network.

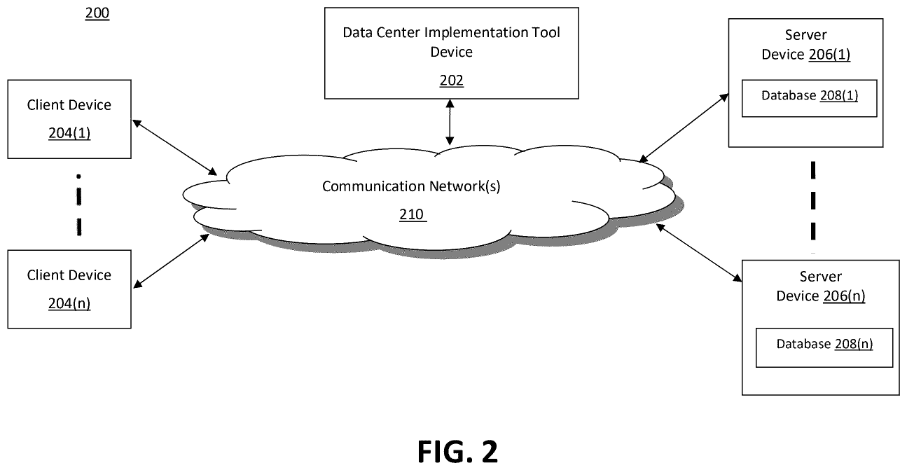

Referring to FIG. 2, a schematic of an exemplary network environment 200 for implementing an IaaS data center within an enterprise network. In an exemplary embodiment, a data center implementation tool may be implemented on any networked computer platform, such as, for example, a personal computer (PC).

A method for implementing a tool that implements an IaaS data center within an enterprise network, may be implemented by a data center implementation tool (DCIT) device 202. The DCIT device 202 may be the same or similar to the computer system 102 as described with respect to FIG. 1. The DCIT device 202 may be a rack-mounted server in a datacenter, an embedded microcontroller (MCU) in an electronic device, or another type of headless system, which is a computer system or device that is configured to operate without a monitor, keyboard and mouse. The DCIT device 202 may store one or more applications that can include executable instructions that, when executed by the DCIT device 202, cause the DCIT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DCIT device 202 itself, may be located in virtual server(s) running in a cloud-based computing environment rather than being tied to one or more specific physical network computing devices. Also, the application(s) may be running in one or more virtual machines (VMs) executing on the DCIT device 202. Additionally, in one or more embodiments of this technology, virtual machine(s) running on the DCIT device 202 may be managed or supervised by a hypervisor.

In the network environment 200 of FIG. 2, the DCIT device 202 is coupled to a plurality of client devices 204(1)-204(n), and also to a plurality of server devices 206(1)-206(n) that hosts a plurality of databases 208(1)-208(n) via communication network(s) 210. A communication interface of the DCIT device 202, such as the network interface 114 of the computer system 102 of FIG. 1, operatively couples and communicates between the DCIT device 202, the client devices 204(1)-204(n), and/or the server devices 206(1)-206(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DCIT device 202, the client devices 204(1)-204(n), and/or the server devices 206(1)-206(n) may be coupled together via other topologies. Additionally, the network environment 200 may include other network devices such as one or more routers and/or switches, for example, which are well known in the art and thus will not be described herein. This technology provides a number of advantages including methods, computer readable media, and DCIT devices that implement a method for a data center implementation tool that implements an IaaS data center within an enterprise network.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. For the purposes of the present disclosure, it should be noted that: the term “remote” may refer to a “physical” and/or “virtual” remoteness; and the term “local” may refer to a “physical” and/or “virtual” locale.

The DCIT device 202 may be a standalone device or integrated with one or more other devices or apparatuses, such as one or more of the server devices 206(1)-206(n), for example. In one particular example, the DCIT device 202 may include or be hosted by one of the server devices 206(1)-206(n), and other arrangements are also possible. As another example, the DCIT device 202 may be integrated with one or more other devices or apparatuses, such as one or more of the client devices 204(1)-204(n). Moreover, one or more of the devices of the DCIT device 202 may be in a same or a different communication network including one or more public, private, or cloud networks, for example.

The plurality of server devices 206(1)-206(n) may be the same or similar to the computer system 102 or the computer device 120 as described with respect to FIG. 1, including any features or combination of features described with respect thereto. For example, any of the server devices 206(1)-206(n) may include, among other features, one or more processors, memories and communication interfaces, which are coupled together by at least one bus or other communication link, although other numbers and/or types of network devices may be used. The server devices 206(1)-206(n) in this example may process requests received from the DCIT device 202 via the communication network(s) 210 according to an HTTP-based and/or JavaScript Object Notation (JSON) protocol, for example, although other protocols may also be used.

The server devices 206(1)-206(n) may be hardware or software or may represent a system with multiple servers in a pool, which may include internal or external networks. The server devices 206(1)-206(n) hosts the databases 208(1)-208(n) that are configured to store data.

Although the server devices 206(1)-206(n) are illustrated as single devices, one or more actions of each of the server devices 206(1)-206(n) may be distributed across one or more distinct network computing devices that together comprise one or more of the server devices 206(1)-206(n). Moreover, the server devices 206(1)-206(n) are not limited to a particular configuration. Thus, the server devices 206(1)-206(n) may contain a plurality of network computing devices that operate using a master/slave approach, whereby one of the network computing devices of the server devices 206(1)-206(n) operates to manage and/or otherwise coordinate operations of the other network computing devices.

The server devices 206(1)-206(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 204(1)-204(n) may also be the same or similar to the computer system 102 or the computer device 120 as described with respect to FIG. 1, including any features or combination of features described with respect thereto. For example, the client devices 204(1)-204(n) in this example may include any type of computing device that can interact with the DCIT device 202 via communication network(s) 210. Accordingly, the client devices 204(1)-204(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 204 is a wireless mobile communication device, i.e., a smart phone.

The client devices 204(1)-204(n) may run interface applications, such as standard web browsers or standalone client applications, which may provide an interface to communicate with the DCIT device 202 via the communication network(s) 210 in order to communicate user requests and other information. The client devices 204(1)-204(n) may further include, among other features, a display device, such as a display screen or touchscreen, and/or an input device, such as a keyboard, for example. The client devices 204(1)-204(n) may host one or more applications that are proprietary to an enterprise that may be secured from eavesdropping, and these applications may be distributed among client devices 204(1)-204(n). The enterprise's distributed applications may include software that is based on microservices architecture, for example.

Although the exemplary network environment 200 with the DCIT device 202, the client devices 204(1)-204(n), the server devices 206(1)-206(n), the databases 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DCIT device 202, the client devices 204(1)-204(n), the server devices 206(1)-206(n), and the databases 208(1)-208(n), for example, may be configured to operate as virtual instances on the same physical machine. In other words, one or more of the DCIT device 202, the server devices 206(1)-206(n), the client devices 204(1)-204(n), and the databases 208(1)-208(n) may operate on a common physical device rather than as separate devices communicating through communication network(s) 210. Additionally, there may be more or fewer client devices 204(1)-204(n), server devices 206(1)-206(n), and databases 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

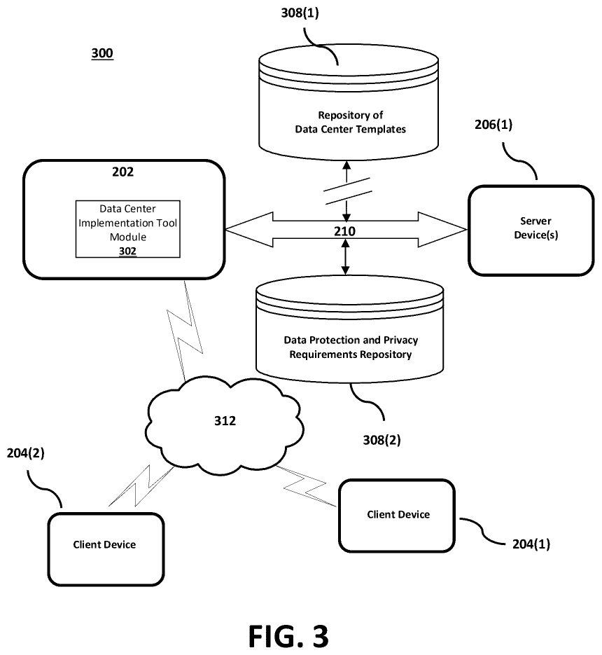

The DCIT device 202 is described and illustrated in FIG. 3 as including data center implementation tool module 302, although it may include other rules, policies, modules, databases, or applications, for example. As will be described below, data center implementation tool module 302 is configured to implement an IaaS data center within an enterprise network. Data center implementation tool module 302 may include software that is based on microservices architecture, for example.

Data center implementation tool module 302 may be integrated with one or more devices or apparatuses, such as client devices 204(1)-204(n), where data center implementation tool module 302 may be implemented as an application or as an addon or plugin to another application of the one or more devices or apparatuses, and where data center implementation tool module 302 may execute in the background.

An exemplary configuration 300 for applying a data center implementation tool to an aspect of the network environment of FIG. 2 is illustrated as being executed in FIG. 3. Specifically, a first client device 204(1) and a second client device 204(2) are illustrated as being in communication with DCIT device 202. In this regard, the first client device 204(1) and the second client device 204(2) may be “clients” of the DCIT device 202 and are described herein as such. Nevertheless, it is to be known and understood that the first client device 204(1) and/or the second client device 204(2) need not necessarily be “clients” of the DCIT device 202, or any entity described in association therewith herein. Any additional or alternative relationship may exist between either or both of first client device 204(1), second client device 204(2) and DCIT device 202.

Data center implementation tool module 302 of DCIT device 202 may communicate with Repository of Data Center Templates 308(1). DCIT device 202 may utilize Repository of Data Center Templates 308(1) to store requirements-based templates of various types of data centers. In addition, data center implementation tool module 302 of DCIT device 202 may also communicate with Data Protection and Privacy Requirements Repository 308(2). DCIT device 202 may utilize Data Protection and Privacy Requirements Repository 308(2) to store at least one data protection and privacy requirement of a jurisdiction. However, Data Protection and Privacy Requirements Repository 308(2) may store: at least one data protection and privacy requirement for more than one jurisdiction; more than one data protection and privacy requirement of a jurisdiction; and/or more than one data protection and privacy requirement for more than one jurisdiction.

In an embodiment, data center implementation tool module 302 may be configured to provide a dynamically customizable interface for selecting, to communicate with, at least one server device at least one from among server devices 206(1)-206(n). Moreover, DCIT device 202 may receive and transmit data via communication network(s) 210. DCIT device 202 may receive and transmit data such as code that is written in one or more of the following dialects: transaction control language (TCL), data manipulation language (DML), data control language (DCL) and data definition language (DFL). Additionally, via communication network(s) 210, DCIT device 202 may respectively receive and transmit data from and to one or more from among client devices 204(1)-204(n) and the server devices 206(1)-206(n).

However, FIG. 3 depicts the first client device 204(1) and the second client device 204(2) as belonging to an enterprise network 312, and DCIT device 202 may communicate with any one or more devices or apparatuses that belong to the enterprise network 312, such as one or more from among client devices 204(1)-204(n). For example, DCIT device 202 may utilize a graphical user interface (GUI) to communicate with one or more from among client devices 204(1)-204(n), and enterprise network 312 may comprise a cluster that belongs to the above-mentioned enterprise that may be secured from eavesdropping. In a further embodiment, enterprise network 312 may comprise a cluster of distributed applications that belong to the enterprise.

The first client device 204(1) may be, for example, a smart phone. Of course, the first client device 204(1) may be any additional device described herein. The second client device 204(2) may be, for example, a personal computer (PC). Of course, the second client device 204(2) may also be any additional device described herein.

The client devices 204(1)-204(n) may represent, for example, computer systems of the enterprise's client network. The first client device 204(1) may represent, for example, one or more computer systems of a client or of a cluster of clients within the enterprise or client network. Of course, the first client device 204(1) may include one or more of any of the devices described herein. The second client device 204(2) may be, for example, one or more computer systems of another client or cluster of clients within the enterprise or client network. Of course, the second client device 204(2) may include one or more of any of the devices described herein.

The process may be executed via the communication network(s) 210, which may comprise plural networks as described above. For example, in an exemplary embodiment, either or both of the first client device 204(1) and the second client device 204(2) may communicate with the DCIT device 202 via broadband or cellular communication. Of course, these embodiments are merely exemplary and are not limiting or exhaustive.

Data center implementation tool module 302 may programmatically configure and communicate with server devices 206(1)-206(n), which may respectively correspond to remote clusters of server devices, such as a server farm, for example.

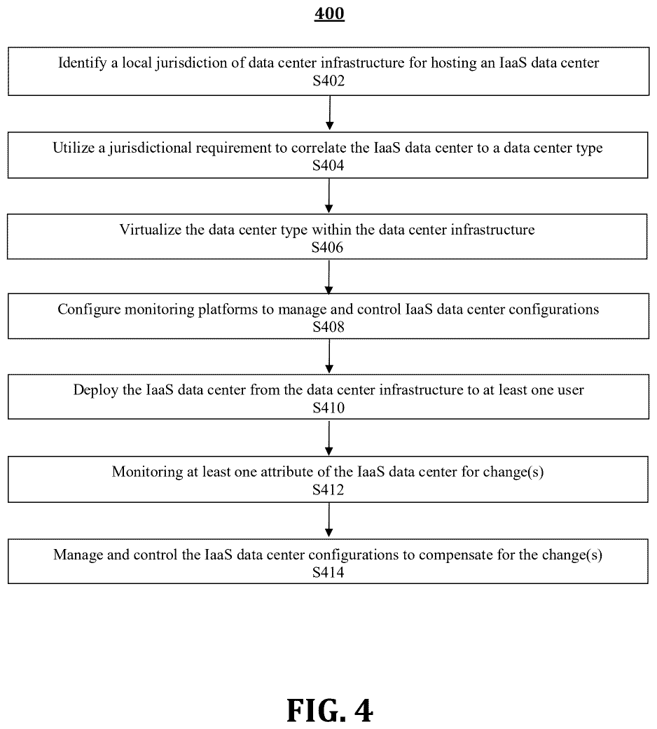

Data center implementation tool module 302 may execute a process that programmatically configures and communicates with one or more server devices from among server devices 206(1)-206(n). An exemplary process for a data center implementation tool is generally indicated at flowchart 400 in FIG. 4.

In process 400 of FIG. 4, at step S402, data center implementation tool module 302 identifies a local jurisdiction of data center infrastructure for hosting an IaaS data center. For example, the data center infrastructure may comprise at least one server device, such as server device(s) 206(1). Data center implementation tool module 302 may identify the local jurisdiction based on a location of the data center infrastructure. The location of the data center infrastructure may refer to a physical location, a virtual location, or both.

After step S402, data center implementation tool module 302 identifies at least one requirement from among a first set of data protection and privacy requirements that pertain to the local jurisdiction. For example, the first set of data protection and privacy requirements may be stored in a set of data protection and/or privacy requirements repositories, such as data protection and privacy requirements repository 308(2). Accordingly, data center implementation tool module 302 may obtain the at least one requirement from data protection and privacy requirements repository 308(2) by identifying data protection and/or privacy requirements that pertain to the local jurisdiction.

At step S404, data center implementation tool module 302 correlates the IaaS data center to a first data center type that is associated with at least one requirement from among a first set of data protection and privacy requirements that pertain to the local jurisdiction. For example, the at least one requirement may require that at least one from among secure data of the local jurisdiction and private data of the local jurisdiction, is non-transitorily stored only within an environment that is isolated from the enterprise network. As another example, the at least one requirement may require that at least one from among secure data of the local jurisdiction and private data of the local jurisdiction is non-transitorily stored only within an environment that is located separately from the enterprise network.

During step S406, the correlation of the IaaS data center may comprise determining that the first data center type comprises a first enterprise environment from among the following enterprise environments: a local enterprise environment that provides the enterprise network with local access to the IaaS data center, a remote enterprise environment that provides the enterprise network with remote access to the IaaS data center, and an isolated enterprise environment that provides the enterprise network with restricted access to the IaaS data center. For example, the IaaS data center may be accessible only via a firewall, and the firewall may be configured to permit at least one from among the remote access and the restricted access.

For example, topologies of a respective plurality of distinct enterprise environments may be stored (as data center templates) within a repository, such as repository of data center templates 308(1).

In process 400, the data center infrastructure may be located separately from the enterprise, the remote access may utilize a communication network, the data center infrastructure may be located within the enterprise, the data center infrastructure may be located separately from the enterprise, the IaaS data center may be isolated, the IaaS data center may be accessible only via a private network channel, and the restricted access may utilize the private network channel. Additionally or alternatively, during step S406, the correlating of the IaaS data center to the first data center type may be based on the at least one requirement from among a first set of data protection and privacy requirements that pertain to the local jurisdiction.

In process 400, the first data center type may comprise at least one data center network tier from among a plurality of data center network tiers, and the plurality of data center network tiers may comprise: a third tier that includes an isolated internal data center network that is inaccessible to an external network, a first tier that includes an accessible internal data center network that is accessible to the external network, and a second tier that includes the intermediate internal data center network. Additionally, the isolated internal data center network may be configured to communicate only with the intermediary internal data center network, the accessible internal data center network may be configured to communicate with the intermediary internal data center network, and the intermediary internal data center network may be configured to communicate only with the isolated internal data center network and the accessible internal data center network, and the external network may comprise the enterprise network.

At step S406, data center implementation tool module 302 instantiates the IaaS data center by virtualizing the first data center type within the data center infrastructure.

During step S406, the virtualization of the first data center type may comprise: (i) configuring the data center infrastructure to implement a first hypervisor and virtual machine topology, (ii) implementing a first operating system (OS) layer on top of the first hypervisor and virtual machine topology, (iii) configuring the first OS layer to include a first set of data center directories, and (iv) configuring the first OS layer to utilize a first protocol to provide access to the first set of data center directories. In process 400, the first data center type may comprise the first hypervisor and virtual machine topology, and the first protocol may comprise at least one from among a lightweight directory access protocol (LDAP) and an active directory protocol, such as a Kerberos authentication protocol, for example.

At step S408, data center implementation tool module 302 configures a first set of monitoring platforms to manage and control a first set of configurations of the IaaS data center.

During step S408, the configuration of the first set of monitoring platforms may comprise configuring at least a first monitoring platform from among the first set of monitoring platforms to perform at least one operation from among the following operations: determine, by monitoring a first set of performance metrics of the IaaS data center, whether the first set of performance metrics comprises a first performance drift of the IaaS data center; adjusting the first set of configurations to compensate for the first performance drift; replacing a defective component of the data center infrastructure with a properly functioning instance of the defective component; and stocking an inventory of the IaaS data center with a new instance of the defective component.

Additionally or alternatively, during step S408, the configuration of the first set of monitoring platforms may comprise configuring at least a second monitoring platform from among the first set of monitoring platforms to perform at least one operation from among the following operations: determine, by monitoring the first set of data protection and privacy requirements, whether the first set of data protection and privacy requirements comprises a critical change pertaining to the IaaS data center; and reconfiguring the IaaS data center in accordance with the critical change of the first set of data protection and privacy requirements that pertain to the local jurisdiction.

At step S410, data center implementation tool module 302 deploys the IaaS data center to at least one data center user of the enterprise network. During step S410, data center implementation tool module 302 may deploy the IaaS data center from the data center infrastructure.

At step S412, data center implementation tool module 302 triggers the first set of monitoring platforms to monitor at least one attribute that pertains to the IaaS data center. During step S412, the monitoring of the at least one attribute may be performed in order to manage and control the first set of configurations that were configured during step S408.

During step S412, at least a first monitoring platform may be triggered to monitor the at least one attribute by performing at least one operation from among the following operations: determine, by monitoring a first set of performance metrics of the IaaS data center, whether the first set of performance metrics comprises a first performance drift of the IaaS data center; and determine, by monitoring the first set of data protection and privacy requirements, whether the first set of data protection and privacy requirements comprises a critical change pertaining to the IaaS data center.

When the monitoring of step S412 determines that the at least one attribute indicates that that there is a critical change in the at least one attribute's value(s), at step S414, at least the first monitoring platform manages and controls the IaaS data center configurations to compensate for the critical change.

For example, at step S414, the first monitoring platform may compensate for the at least one attribute's critical change by: adjusting the first set of configurations to compensate for the first performance drift, replacing a defective component of the data center infrastructure with a properly functioning instance of the defective component, and stocking an inventory of the IaaS data center with a new instance of the defective component. In an example, in response to step S412, the first monitoring platform may be triggered to perform all these operations.

As another example, at step S414, the first monitoring platform may compensate for the at least one attribute's critical change by reconfiguring the IaaS data center in accordance with the critical change of the first set of data protection and privacy requirements that pertain to the local jurisdiction.

Although data center implementation tool module 302 has been described as being utilized to implement one data center, it should be noted that data center implementation tool module 302 may perform steps S402-S410 whenever an additional data center is required.

In implementations of the invention described herein, the data center infrastructure may comprise more than one server device from among server devices 206(1)-206(n). Also, in implementations, at least one user may utilize one or more client devices—such as client devices 204(1)-204(2)—to interface with data center implementation tool module 302. For example, data center implementation tool module 302 may utilize a graphical user display (GUI) of a client device 204 to display the status, progress and/or results of any combination of process 400's operations. Also, data center implementation tool module 302 may utilize the GUI to illustrate the topology and/or architecture of the data center infrastructure and or the IaaS data center. Moreover, the at least one user may utilize the one or more client devices to configure data center implementation tool module 302 to perform any combination of process 400's operations.

Accordingly, the present invention may be utilized by an enterprise or its designers and engineers to comply with data restrictions and IT outsourcing law specific to any local region or country. The present invention may be utilized (on multiple occasions) to meet data center requirements, build data centers, and provide compute provisioning in an isolated network segment.

Additionally, as described herein, the improvement of the present invention leverages the fact that reactive responses to data center requirements can be time consuming due to the planning and implementation involved combined with the many unexpected problems that may arise while implementing a response.

According to implementations, the present invention may be utilized to create at least one data center template, which may be utilized to deploy a data center (such as the IaaS data center, for example) with location specific tools and technology.

The present invention may include three (3) types of data center deployments. For example, the data center deployments may include: a standard deployment (i.e., a “type 1” or “fully connected” data center, such as with data centers typically associated with locations in Singapore, for example); a remote deployment (i.e., a “type 2”, “long line” or “semi-isolated” data center, such as with data centers typically associated with locations in China, Geneva, Argentina, Switzerland, for example; and an isolated deployment (i.e., a “type 3” or “completely isolated” data center, such as with data centers typically associated with locations within a restrictive foreign jurisdiction).

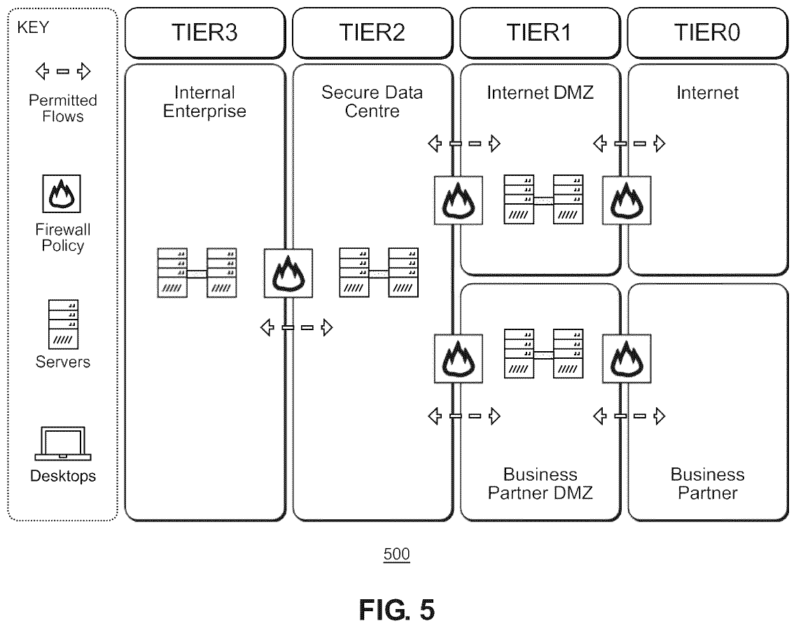

According to implementations, the present invention may comprise a plurality of tiers, such as a three (3) tier system, which has three (3) types of network implementations in a data center, where the first tier (i.e., tier 1) may be directly connected to the Internet in order to host application services that require internet user interaction(s). For security purposes, tier 1 networks may not be permitted to connect directly to a tier 3 network. Rather, to minimize network security risks by reducing tier 1's exposure to the Internet, tier 1 networks may be permitted to connect only to application services indirectly via a direct connection through a firewall that lies between tier 1 and tier 2 networks. Such an exemplary three tier system is depicted in system 500 of FIG. 5.

According to implementations of the present invention, tier 2 networks may serve as an intermediate network that lies between tier 1 and tier 3 networks. Servers and/or services that connect to tier 1 may be hosted in a tier 2 network, and the servers and/or services hosted in the tier 2 network may communicate with tier 1 and tier 3 networks through respective firewalls. For example, the tier 2 network may host an interface for an authentication service, a system and/or server that monitors and manages drift, etc.

Additionally, tier 3 networks may serve as internal networks where all core servers and services may be hosted and from which unrestricted communications may be deployed. As previously stated, tier 3 communications may be limited to transmissions to (and from) tier 2 that pass through at least one firewall that has been configured to permit only transmissions to tier 3 from tier 2 (and from tier 3 to tier 2), which may thereby serve as an intermediate network for tier 1's Internet-facing servers or services that interact with a tier 3 network.

According to implementations, the present invention may identify tools to be deployed by, for example, identifying the resources (e.g., IaaS resources) required to enable an enterprise compute that may be required to implement a new data center, such as an IaaS data center for example. Additionally, based on the pros and cons of the available options, the present invention may determine the hardware necessary to implement a new data center and, based on the pros and cons of available hardware options, the present invention may select and obtain the best option(s) from the available hardware for implementing a new data center. Moreover, by utilizing hardware from a plurality of vendors, the present invention may also be employed to prevent the vendor lock in.

According to implementations, the present invention may also identify which tools to deploy by, for example, determining an appropriate hypervisor for implementing a new data center, such as the data center described above. A hypervisor may refer to a virtual machine manager (VMM). According to the present invention, hypervisor technology may be hosted on hardware and utilized to virtualize the data center and, by provisioning virtual machines, such hypervisor technology may also reduce the data center's hardware resource requirements. Therefore, the present invention may evaluate the hypervisor technology options that are available and determine the most appropriate hypervisor technology option(s) to utilize for the data center's implementation.

According to implementations, the present invention may also identify which tools to deploy by, for example, determining an appropriate operating system (OS) for implementing a new data center, such as the data center described above.

According to implementations, the present invention may also identify which tools to deploy by, for example, determining an appropriate authentication model for implementing a new data center, such as the data center described above. According to implementations, the present invention's authentication model may utilize an active directory based setup, for example, the present invention's authentication model may utilize at least one from among a lightweight directory access protocol (LDAP). According to further implementations, the present invention may employ a Linux-based LDAP, for example.

According to implementations, the present invention may also identify which tools to deploy by, for example, determining an appropriate maintenance system for managing data center performance metric drift corrections and the integrity (and/or compliance) of the data center's configurations. Available options for such maintenance include, but are not limited to, implementations such as Ansible, Puppet, Chef, Salt, Ivanti, etc. For example, according to implementations of the present invention, Evolveen may be utilized to monitor a data center for at least one performance metric drift that pertains to a critical system of the data center.

According to implementations, the present invention may also identify which tools to deploy by, for example, determining an appropriate inventory management system for the data center. Such inventory management systems may comprise at least one from among an in-house (or proprietary) implementation, an open source implementation, and a commercial implementation of an external vendor. According to implementations of the present invention, in-house tools may be built on top of at least one from among a non-relational/non-structured query language (NoSQL) database and a relational database management system (RDBMS), by utilizing application programming interface (API) and user interface (UI) technologies.

According to implementations, the present invention may utilize open-source tools for small data center implementations. Such open-source options may include, but are not limited to InvenTree, NetBox, SNIPEIT etc. Commercial inventory management systems may be obtains from vendors, such as HP, CMDB, and Ivanti, for example.

Similarly, according to implementations, the present invention may also identify which tools to deploy by, for example, determining an appropriate monitoring tool to monitor the data center's components and applications. According to implementations, the present invention's monitoring system may comprise at least one from among a monitoring recommendation system (e.g., Nagios, Genos, Scom, Tivoli, etc.), a metrics collection, distributed tracing and visualization system (e.g., Grafana, Prometheus, Centreon etc.), an application performance, monitoring and synthetic testing system (e.g., AppDynamics, Dynatrace, Thousand Eyes, etc.), log collections (e.g., Elastic search and Kibana, Splunk etc.), and telemetry transportation (e.g., databus).

Aspects of the present invention may also pertain to templates for bootstrapping at least one data center and also pertains to enabling Infrastructure-as-a-Service (IaaS) such as “enterprise compute” resources provided in at least one from among a non-isolated environment, a semi-isolated environment, and an air-gapped (i.e., isolated) environment. One of these templates may be utilized to deploy a data center that includes location specific tools and technologies.

As per legal requirements for information security tools and services as well as legal requirements for outsourced information technology (IT) services, to support local services, an enterprise may have to utilize local infrastructure and/or a local license provider. IT service host(s) and application(s) may be required to enable such IT services. Therefore, there is need to configure IT Infrastructure by, for example, configuring any necessary enterprise compute resources. Accordingly, the present invention may design setups that may provide a simple, repeatable, and reliable system for provisioning an air-gapped data center in foreign locations.

An exemplary presidential decree and recent draft law on outsourcing may establish new requirements for the use of information security tools and services as well as outsourced IT services, such as cloud services. In order to operate, this Presidential Decree may requires that its jurisdiction's subsidiaries of foreign financial enterprises establish local infrastructure within the jurisdiction, utilize the jurisdiction's license providers, and comply with new regulatory requirements. The Presidential Decree sets out information security requirements for infrastructure pertaining to critical national information.

The Presidential Decree may prohibit entities that do not have a license for the provisioning of data protection services, from receiving information security services, and it should be noted that only the jurisdiction's entities may possess such a license. The license is called a “license for technical protection of confidential information,” but its scope covers all information security tools.

The Presidential Decree may also prohibit the use of information security hardware and software including those for cyber defense and fraud detection, cyber operations, endpoint and network security provided by suppliers located within jurisdictions who are categorized as “unfriendly,” such as the United Kingdom (the UK) and the United States (the US). The Presidential Decree may fully goes into effect on a future date. Accordingly, foreign financial enterprises that are located in the jurisdiction will be required to build out and support new on shore technology infrastructures in the jurisdiction for hosting applications, OSs, databases, storage systems, and networks.

Part 1 of the Presidential Decree may already be in effect, and Part 2 of that decree may go into effect on the future date. In mid-2025, the jurisdiction's IT Outsourcing Law may be expected to establish new technology requirements for IT services, information security tools and information security services that pertain to the jurisdiction's local subsidiaries of foreign financial institutions. In response to these critical regulatory changes, the present invention may be utilized to redesign the jurisdiction's local technologies to support a fully isolated domain where all technology and security services may be built and operated locally without depending on a foreign firm or institution's private enterprise network, while still remaining compliant with requirements that may be stipulated in the jurisdiction's main information security regulation.

In implementations, for the jurisdiction, the present invention may be utilized to build a fault tolerant environment that may comprise a standalone (e.g., air-gapped and/or isolated) setup for provisioning at least one compute instance to enable compute capacities in a manner similar to Internet computer protocol (ICP), but without corporate automation or control planes, which may be operated in the jurisdiction.

The enablement of “Enterprise compute” may be divided into four phases. During phase 1, basic network and compute may be enabled and basic hardware setup will be installed and made available to start provisioning for infrastructure services and others. During phase 2, an OS may be installed within infrastructure services. All the required infrastructure services may be installed, configured and enabled in order to bootstrap an air-gapped data center to provide all the infrastructure services available for subsequent business system provisioning. During phase 3, application server provisioning may be initiated. All server provisioning may be completed based upon at least one regulatory requirement. During phase 4, if any baselines (e.g., Windows defender) are defined, then they will be enabled either manually or through automation, and such automation may depend on a scale of deployment vs consumption tradeoff.
Phase-1: Minimum—There may be hardware available which may be utilized either for Bespoke, Hyper V or ESX setup; Network setup completed with air gapped requirement; Network setup should be matching with ESX requirement; There will be connectivity either via jump host or remote hand on boarded.
Phase-2: As per recommendation, a prescribed number of servers that are required to operate a data center, may be installed with target OS; Services in infrastructure stack may be configured and running; Infrastructure services may be available in the segregated network zone configured for the jurisdiction.
Phase-3: All the servers may be provisioned with desired capacity as per initial requirement; All the compute capacity with storage may be provisioned as per initial requirement from EP and other GT service provider. For example, Email, SharePoint etc.; All the provisioned compute instances may be available to respective for their setup, testing etc.
Phase-4: Local resources may be fully available as per support commitment; Local resources for OS may be available for support and configuration of system provisioned in phase-1, 2 & 3; Local resources can perform independently with minimum or no support from Base Compute; Automation may be finalized and prioritized based up on business requirement; Timeline for automation may be defined; Resource and headcount allocation for automation may be finalized; Skeleton to build the automation may be defined; Technology for the automation may be finalized and started.

Enterprise OS resources may push raw images (e.g., database disk images) for example (with MD5 sign) to isolated data centers that are remotely located. Such raw disk images may have been obtained from at least one original image manufacturer such as, for example, Windows and/or Red Had from Microsoft and IBM, respectively. Enterprise OS resources may build a different image and make it available in an image store. To reduce risk or blast radius, implementations of the present invention may have two different Hyper-V cluster setups. A first Hyper-V cluster setup to provision the system related infrastructure services hosting, and a second Hyper-V cluster setup may be available for enterprise compute.

A user acceptance testing (UAT) setup for enterprise compute may be used for system integration testing of enterprise compute's feature to ensure that new patches, hotfixes or features are properly integrated with other services.

As mentioned above, a data center may comprise one or more tiers (or types) of network setup(s) whereas tier 1 is internet facing. A tier 1 network may host application services that interact with the Internet. Hence, for security purposes, tier 1 networks may have no direct connections to tier 3. Tier 1 may only connect to tier 2 applications and/or services at least one firewall to minimize the risk and reduce tier 1's exposure to external networks.

Turning to tier 2, this network tier falls between tier 1 and tier 3. Accordingly, this may be referred to as an intermediate tier. Tier 2 may be utilized to host any servers or services that connect to tier 1. Serves or services hosted in tier 2 may communicate with tier 1 and tier 3 through the at least one firewall. For example, tier 2 may be utilized to host an interface for an authentication model, a system or server for drift monitoring and management, etc.

Tier 3 is an internal network, and all core servers and services may be hosted here without any restrictions. According to implementations of the present invention, tier 3 may only communicate with servers or services hosted in tier 1, via tier 2 and the at least one firewall, and tier 2 may be communicated with by servers or services hosted in tier 3 only via tier 1 and the at least one firewall.

According to implementations of the present invention, after identifying the tools to deploy, the data center's compute capacity may be identified. When identifying this compute capacity for day zero (where “day zero” refers to the “time or day preceding to public deployment”) requirements a minimum 10% cap may be added on top of required day zero compute capacity, and this may be recorded on a bill of materials sheet.

According to implementations of the present invention, once the compute capacity is identified, then the placement of hardware may be planned by obtaining hardware an evaluating physical space requirements for housing the hardware.

According to implementations of the present invention, after placement planning, architecture may be constructed for a target state, and such construction be performed in parallel with previous steps.

According to implementations of the present invention, based upon the architecture the bill of material sheet may be validated, and any necessary changes may be accommodated, after which the hardware may be obtained.

According to implementations of the present invention, a tactical build may now be deployed for testing. Once the hardware has been obtained, the target network may be constructed and, as a point of contact, a small setup may be deployed as a prototype to test the planning execution. Also, the strategic deployment may be improved based on feedback from any tactical phases. This step can be executed in parallel while preparing the target state, which may be larger than the prototype that may be tested.

To deploy a strategic build, input from the result of the tactical phase may be utilized to deploy a strategic solution as follows.
During a first step (step 1), hardware that has been obtained may be integrated and/or installed on their appropriate rack(s), which may include hardware installations of servers, storage devices, network cables, and power supply resources and cables.
During a second step (step 2), the most appropriate hypervisor for the data center may be installed from the identified tools mentioned above.
During a third step (step 3), virtual machines may be implemented and at least one OS may be installed thereon in order for the host infrastructure to provide basic infrastructure services. Once the at least one OS is installed, the system may be configured to enable the basic infrastructure services, which may include: A) Active directory; B) domain name server (DNS) services; C) pre-boot execution environment (PXE) service for automated installation; D) other installation and configuration tools for monitoring, drift management, and inventory management, for example.
During a fourth step (step 4), when the above setup is complete, infrastructure services may be available to provision an enterprise compute, and the data center may provision such an enterprise compute, systems, servers, and/or virtual machines as required by at least one demand and/or requirement that is identified in the BOM for day zero.
Additionally, during a fifth step (step 5), automation may also be setup by utilizing configuration management for the provisioning of any required tools.

As mentioned above, data center type specific processes may include three (3) types, for example. Type 1 data center deployments may comprise data center deployments that are fully connected to an enterprise network, which may belong to an organization such as a corporation (e.g., an enterprise corporate network). Therefore, type 1 data centers are the simplest deployment and may be connected to all the standard tools and technology that already exists within the enterprise network.

Type 2 data center deployments may provide a long lined connection to an enterprise corporate network that passes through at least one firewall in order to comply with the local regulations. In type 2 deployments, lists of ports may be opened between the enterprise network's standard tool and the data center deployment.

Type 3 data center deployments may be completely isolated and air gapped from the corporate network. In type 3 deployments, there may be small scale placements of all standard tools for hosting infrastructure services and automations.

Compute capacity may include any computer or server provisioning that is necessary for full functionality, which may comprise the bare minimum commissioning of computer resources available, which may be utilized as a unit. According to implementations of the present invention, compute capacity may include (but is not limited to) commissioning CPUs, memory and storage with an OS and basic tools installed at minimum.

Air gapped connectivity refers to when there is a complete air gap (e.g., isolation) between two network segments. For connectivity, connections may be established via the Internet.

Exemplary ports are list in table 1.

TABLE 1
Standard Ports

| Tool | Technology | Port |
|---|---|---|
| Active | Active | active-directory/config- |
| Directory | Directory | firewall-for-ad-domains-andtrusts |
| LDAP | LDAP | 389 |
| Config | Puppet | 8140 |
| Management | Ansible | 22 (For linux), Winrm (5985, |
| | | 5986), Receptor (27199) |
| | Chef | 80, 443, 9683 etc. |
| | Salt | 4505, 4506 |
| | Ivanti | 8443 |
| Drift Reporting | Evolveen | |
| Inventory mgmt. | InvenTree, | |
| (Open source) | NetBox, SNIPEIT | |
| Inventory mgmt. | HP CMDB, Ivanti | |
| (Paid) | | |
| OS | DNS | 53 |
| | SSH | 22 |
| | FTP | 21 |
| | SFTP | 22 |
| | DHCP | 67 |
| | SMTP | 25 / 587 |
| Monitoring / | Nagios | 161, 162 |
| Telemetry | Scom | 5723 |
| | Tivoli | 3660 |
| | AppDynamics | 9191 |
| | ThousandEyes | 49152 |
| | Elastic search | 9200, 9300 |
| | Splunk | 8089, 8000 |

It should be noted that the number of ports listed in Table 1 may increase or decrease based upon requirements and/or vendor recommendations. An exemplary set of requirements (based on total demand) are listed in Table 2, where *approximately 20% of resources may be utilized at Hyper-V layer). As utilized herein, the term “node” may be utilized to refer to a device such as a “server,” for example.

In Table 2, “Tab-1 (Core Services)” corresponds to core services and contains a list of infrastructure services that may be required to function the setup in the data center, such as a domain naming system (DNS), an active directory, a time service/NTP, email security services, a Dynamic Host Control Protocol (DHCP), etc. Also, in Table 2, “Tab-2 (Resource Demand)” corresponds to compute resources demand, which refers to the compute resources required to host an exemplary data center in a foreign location, which may be a restricted location or country. Moreover, in Table 2, “Day 0 demand” refers to a capacity required for the exemplary data center to go live.

TABLE 2
Total VSI Demand

| | | | Memory | Local Storage | Network Storage |
|---|---|---|---|---|---|
| | Nodes | CPU | (in GB) | (in GB) | (in TB) |
| Tab- 1 (Core Services) | 149 | 1704 | 10808 | 8500 | 240.8 |
| OS Disk (150 GB / node) | | | | 34350 | |
| Tab-2 (Resource Demand) | 80 | 389 | 2828 | 0 | 150 |
| Total Day 0 Demand | 229 | 2093 | 13636 | 42850 | 390.8 |
| 10% forecast | 22.9 | 209.3 | 1363.6 | 4285 | 39.08 |
| 20% for Hyper-V* | | 460.46 | 2999.92 | 9427 | 0 |
| Total Day 0 requirement | 480.9 | 2762.76 | 17999.52 | 56562 | 429.88 |

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for implementing an Infrastructure-as-a-Service (IaaS) data center within an enterprise network, the method comprising:
identifying, based on a location of data center infrastructure for hosting the IaaS data center, a local jurisdiction of the data center infrastructure;
correlating the IaaS data center to a first data center type that is associated with at least one requirement from among a first set of data protection and privacy requirements that pertain to the local jurisdiction;
instantiating the IaaS data center by virtualizing the first data center type within the data center infrastructure;
configuring a first set of monitoring platforms to manage and control a first set of configurations of the IaaS data center; and
deploying, from the data center infrastructure, the IaaS data center to at least one data center user of the enterprise network.

2. The method of claim 1, wherein the virtualizing comprises at least one from among:
configuring the data center infrastructure to implement a first hypervisor and virtual machine topology, wherein the first data center type comprises the first hypervisor and virtual machine topology;
implementing a first operating system (OS) layer on top of the first hypervisor and virtual machine topology;
configuring the first OS layer to include a first set of data center directories; and
configuring the first OS layer to utilize a first protocol to provide access to the first set of data center directories.

3. The method of claim 2, wherein the first protocol comprises at least one from among a lightweight directory access protocol (LDAP) and an active directory protocol.

4. The method of claim 1, wherein the first data center type comprises at least one data center network tier from among a plurality of data center network tiers, and the plurality of data center network tiers comprises:
a third tier that includes an isolated internal data center network that is inaccessible to an external network, wherein the isolated internal data center network is configured to communicate only with an intermediary internal data center network, and wherein the external network comprises the enterprise network;
a first tier that includes an accessible internal data center network that is accessible to the external network, wherein the accessible internal data center network is configured to communicate with the intermediary internal data center network; and
a second tier that includes the intermediary internal data center network, wherein the intermediary internal data center network is configured to communicate only with the isolated internal data center network and the accessible internal data center network.

5. The method of claim 1, wherein configuring the first set of monitoring platforms comprises configuring at least a first monitoring platform from among the first set of monitoring platforms to at least one from among:
determine, by monitoring a first set of performance metrics of the IaaS data center, whether the first set of performance metrics comprises a first performance drift of the IaaS data center;
adjust the first set of configurations to compensate for the first performance drift;
replace a defective component of the data center infrastructure with a properly functioning instance of the defective component; and
stock an inventory of the IaaS data center with a new instance of the defective component.

6. The method of claim 1, wherein configuring the first set of monitoring platforms comprises configuring at least a second monitoring platform from among the first set of monitoring platforms to at least one from among:
determine, by monitoring the first set of data protection and privacy requirements, whether the first set of data protection and privacy requirements comprises a critical change pertaining to the IaaS data center; and
reconfigure the IaaS data center in accordance with the critical change of the first set of data protection and privacy requirements that pertain to the local jurisdiction.

7. The method of claim 1, wherein the correlating comprises determining, based on the requirement, that the first data center type comprises a first enterprise environment from among the following enterprise environments:
a local enterprise environment that provides the enterprise network with local access to the IaaS data center, wherein the data center infrastructure is located within the enterprise;
a remote enterprise environment that provides the enterprise network with remote access to the IaaS data center, wherein the data center infrastructure is located separately from the enterprise, and wherein the remote access utilizes a communication network; and
an isolated enterprise environment that provides the enterprise network with restricted access to the IaaS data center, wherein the data center infrastructure is located separately from the enterprise, wherein the IaaS data center is isolated, wherein the IaaS data center is accessible only via a private network channel, and wherein the restricted access utilizes the private network channel.

8. The method of claim 7, wherein the IaaS data center is accessible only via a firewall, and wherein the firewall is configured to permit at least one from among the remote access and the restricted access.

9. The method of claim 1, wherein the at least one requirement requires that at least one from among secure data of the local jurisdiction and private data of the local jurisdiction is non-transitorily stored only within an environment that is isolated from the enterprise network.

10. The method of claim 1, wherein the at least one requirement requires that at least one from among secure data of the local jurisdiction and private data of the local jurisdiction is non-transitorily stored only within an environment that is located separately from the enterprise network.

11. A system for implementing an Infrastructure-as-a-Service (IaaS) data center within an enterprise network, the system comprising:
a processor; and
memory storing instructions that, when executed by the processor, cause the processor to perform operations comprising:
identifying, based on a location of data center infrastructure for hosting the IaaS data center, a local jurisdiction of the data center infrastructure;
correlating the IaaS data center to a first data center type that is associated with at least one requirement from among a first set of data protection and privacy requirements that pertain to the local jurisdiction;
instantiating the IaaS data center by virtualizing the first data center type within the data center infrastructure;
configuring a first set of monitoring platforms to manage and control a first set of configurations of the IaaS data center; and
deploying, from the data center infrastructure, the IaaS data center to at least one data center user of the enterprise network.

12. The system of claim 11, wherein when the instructions are executed by the processor, the virtualizing comprises at least one from among:
configuring the data center infrastructure to implement a first hypervisor and virtual machine topology, wherein the first data center type comprises the first hypervisor and virtual machine topology;
implementing a first operating system (OS) layer on top of the first hypervisor and virtual machine topology;
configuring the first OS layer to include a first set of data center directories; and
configuring the first OS layer to utilize a first protocol to provide access to the first set of data center directories.

13. The system of claim 11, wherein when the instructions are executed by the processor, the first data center type comprises at least one data center network tier from among a plurality of data center network tiers, and the plurality of data center network tiers comprises:
a third tier that includes an isolated internal data center network that is inaccessible to an external network, wherein the isolated internal data center network is configured to communicate only with an intermediary internal data center network, and wherein the external network comprises the enterprise network;
a first tier that includes an accessible internal data center network that is accessible to the external network, wherein the accessible internal data center network is configured to communicate with the intermediary internal data center network; and
a second tier that includes the intermediary internal data center network, wherein the intermediary internal data center network is configured to communicate only with the isolated internal data center network and the accessible internal data center network.

14. The system of claim 11, wherein when the instructions are executed by the processor, configuring the first set of monitoring platforms comprises configuring at least a first monitoring platform from among the first set of monitoring platforms to at least one from among:
determine, by monitoring a first set of performance metrics of the IaaS data center, whether the first set of performance metrics comprises a first performance drift of the IaaS data center;
adjust the first set of configurations to compensate for the first performance drift;
replace a defective component of the data center infrastructure with a properly functioning instance of the defective component; and
stock an inventory of the IaaS data center with a new instance of the defective component.

15. The system of claim 11, wherein when the instructions are executed by the processor, configuring the first set of monitoring platforms comprises configuring at least a second monitoring platform from among the first set of monitoring platforms to at least one from among:
determine, by monitoring the first set of data protection and privacy requirements, whether the first set of data protection and privacy requirements comprises a critical change pertaining to the IaaS data center; and
reconfigure the IaaS data center in accordance with the critical change of the first set of data protection and privacy requirements that pertain to the local jurisdiction.

16. The system of claim 11, wherein when the instructions are executed by the processor, the correlating comprises determining, based on the requirement, that the first data center type comprises a first enterprise environment from among the following enterprise environments:
a local enterprise environment that provides the enterprise network with local access to the IaaS data center, wherein the data center infrastructure is located within the enterprise;
a remote enterprise environment that provides the enterprise network with remote access to the IaaS data center, wherein the data center infrastructure is located separately from the enterprise, and wherein the remote access utilizes a communication network; and
an isolated enterprise environment that provides the enterprise network with restricted access to the IaaS data center, wherein the data center infrastructure is located separately from the enterprise, wherein the IaaS data center is isolated, wherein the IaaS data center is accessible only via a private network channel, and wherein the restricted access utilizes the private network channel.

17. The system of claim 16, wherein the IaaS data center is accessible only via a firewall, and wherein the firewall is configured to permit at least one from among the remote access and the restricted access.

18. A non-transitory computer-readable medium for implementing an Infrastructure-as-a-Service (IaaS) data center within an enterprise network, the computer-readable medium storing instructions that, when executed by a processor, cause the processor to perform operations comprising:
identifying, based on a location of data center infrastructure for hosting the IaaS data center, a local jurisdiction of the data center infrastructure;
correlating the IaaS data center to a first data center type that is associated with at least one requirement from among a first set of data protection and privacy requirements that pertain to the local jurisdiction;
instantiating the IaaS data center by virtualizing the first data center type within the data center infrastructure;
configuring a first set of monitoring platforms to manage and control a first set of configurations of the IaaS data center; and
deploying, from the data center infrastructure, the IaaS data center to at least one data center user of the enterprise network.

19. The computer-readable medium of claim 18, wherein the at least one requirement requires that at least one from among secure data of the local jurisdiction and private data of the local jurisdiction is non-transitorily stored only within an environment that is isolated from the enterprise network.

20. The computer-readable medium of claim 18, wherein the at least one requirement requires that at least one from among secure data of the local jurisdiction and private data of the local jurisdiction is non-transitorily stored only within an environment that is located separately from the enterprise network.
